(19) United States
(12) Patent Application Publication
(10) Pub. No.: US 2008/0016885 A1
(43) Pub. Date: Jan. 24, 2008

(54) Dry ice cloud generator and method

(76) Inventor: Brian Hoover, Souderton, PA (US)

Correspondence Address: CHARLES N. QUINN;FOX ROTHSCHILD LLP, 2000 MARKET STREET, 10TH FLOOR, PHILADELPHIA, PA, 19103, US

(21) Appl. No.: 11/827,377

(22) Filed: Jul. 10, 2007

Related U.S. Application Data
(60) Provisional application No. 60/830,230, filed on Jul. 10, 2006.

(51) Int. Cl. F17C 7/04; F17C 9/02

(52) U.S. Cl. 62/50.2; 62/440

(57) ABSTRACT

Apparatus for generating the appearance of clouds by forcing air over dry ice and channeling the resultant cloud out the top of an enclosure. The apparatus includes an insert having four sides, a bottom and an open top. A manifold may be coupled to a perforation in the insert wherein an optional silo may extends from the manifold toward the open top of the insert. The manifold and silo may be adapted to store dry ice, or dry ice may be stored in a chamber juxtaposed to the manifold. A fan juxtaposed to manifold forces air into the manifold and, ultimately, over the dry ice. The resultant cloud is then channeled out of the manifold by a diffuser plate and, ultimately, out of the enclosure. In one embodiment, feet beneath the manifold provide a gap between the enclosure and the apparatus such that the cloud exits the enclosure.

### CROSS-REFERENCE TO RELATED APPLICATION

This application claims priority from and the benefit of the filing date of U.S. provisional patent application Ser. No. 60/830,230 filed Jul. 10, 2006 in the name of Brian Hoover entitled “DRY ICE CLOUD GENERATOR AND METHOD”.

### BACKGROUND OF THE INVENTION

1. Field of the Invention

This invention relates to generating the appearance of clouds through use of dry ice and water in conjunction with beverage dispensing or for amusement purposes.

2. Description of the Prior Art

Beverage consumption, particularly beer consumption, is perceived to be more pleasurable if the beverage is consumed in cool or even cold surroundings. A consumer's perception that the most enjoyable beverage comes from, or has been stored in, an extremely cold environment, such as in snow or in a blizzard, is enhanced by numerous contemporary television commercials, many of which are aired in conjunction with the broadcast of sporting events, such as baseball.

Since baseball is played largely in the summer when the weather is warm, spectators at baseball games and within similar amusement venues desire cold beverages for refreshment. To the extent a beverage consumer and such spectators have the perception that their beverages come from storage and dispensing areas that are exceedingly cold, the spectator's desire and thirst for the beverages increases. To this end, an apparatus and method are desired to create and communicate a cold beverage such that the spectator's desire and thirst for beverage is aroused. The present invention addresses this need.

### OBJECTS OF THE INVENTION

The object of this invention is to provide artificial cold clouds at locales at which beverages, such as beer, are dispensed, with particular emphasis on providing such cold clouds in an amusement venue such as a baseball stadium.

### SUMMARY OF THE INVENTION

The present invention provides an apparatus and method for controlling and containing flow of ambient air around and through dry ice to create and control what appears to be cold clouds for creating the perception of a cooling effect for beverages being dispensed close to the apparatus. More specifically, the apparatus and method of the present invention forces ambient air to contact the dry ice such that vapor, appearing to be a cold cloud or even smoke, is produced. Air is directed in such a fashion that even as the dry ice settles, changes shape and builds up insulative frost against the walls of the apparatus, air is still forced to contact the dry ice through use of baffles or perforations, thereby resulting in the desired cold clouds or smoke appearing to emanate continuously from the apparatus.

In one embodiment, the present invention is comprised of an insert and an enclosure, such as a vendor box for distributing beverages. The insert may be comprised of four sides, a perforate bottom or a bottom with at least one hole and an open top wherein the insert is of a rectangular configuration. The sides of the insert may taper from the top to the bottom to define a bottom area of the box that is smaller than the top area of the box. A manifold may be proximate to and coupled to the perforate bottom of the insert and may be adapted to retain dry ice therein. Extending from the bottom of the insert is a diffuser plate wherein the diffuser plate is in communication with the manifold and channels air, having passed over dry ice within the manifold, laterally along the perforate bottom of the rectangular box. Feet protruding downwardly from the perforate bottom of the insert may support the insert within the enclosure.

An upstanding storage silo may be coupled to and extend from a top of the manifold such that the storage silo is in fluid communication with the manifold and downwardly guides dry ice that is inserted into the top of the silo to the interior of the manifold. A fan may be mounted within the silo proximate the top thereof, such that the fan drives air downward within the silo into the manifold. Additionally, a lid may be mounted on the top end of the silo such that the lid prevents debris from entering the silo and dry ice from escaping the silo in the event the insert or vendor box is overturned. Moreover, the lid may be adapted to cover the top end of the silo while allowing air to pass through the lid and silo.

The insert is adapted to fit within an enclosure, wherein the enclosure may be a vendor box of the type conventionally used in an entertainment venue such as in stadium to carry beverages through the spectator stands for sale thereof to the spectators. To this end, the insert is dimensioned to fix within the enclosure such that the top of the silo is below the upper edge of the vendor box and gaps exist between the outer surfaces of the rectangular box and the interior surfaces of the vendor box.

In operation, a user may insert dry ice through the open top of the silo such that it settles, ultimately, in the manifold or within the silo. Warm air may be forced through the top of the silo by a fan wherein the air is forced downwardly through the silo and into the manifold such that it passes over the dry ice. Warm air over the dry ice causes the dry ice to sublimate to some extent and the cold dry ice causes moisture in the air to condense. This creates a cold-appearing cloud as the sublimated, now gaseous, carbon dioxide from the dry ice and the condensed water vapor are carried by the air forced from the fan and directed by the diffuser plate upwardly and outwardly from the enclosure through the gap between the enclosure and the insert. Accordingly, cold beverages may be stored within the insert and/or enclosure such that the carbon dioxide and water vapor signals to patrons of the entertainment venue the presence of a cold beverage for sale.

In an alternative embodiment, the present invention may be adapted to fit within a beverage kiosk such that air is forced over dry ice from a fan mounted on the side of the insert, rather than the top of a silo. More specifically, the apparatus has an outer wall and an inner wall separated by insulation. A fan is mounted on one of the outer walls and is adapted to introduce air flow from outside the insert into the manifold through a side wall of the insert. For example, the air flow may be directed by a fan mounted over a plurality of air passages in the inner and outer walls for passage therethrough. The manifold is bounded in part by a diffuser plate that is spaced away from the inner surface of inner wall to define the manifold. Diffuser plate has a canted portion located at the bottom of diffuser plate wherein the canted portion directs the air flow over the dry ice. Finally, the insert further includes a flap coupled to a lid which, in turn, is mounted to the insert. During operation, the flap is in an upright position thereby to creating an exhaust opening at an upper extremity of the open interior of the rectangular box-like portion of apparatus. Accordingly, the fan passes ambient air over the dry ice to create the carbon dioxide and vapor mist. This mist signals the presence of a cold beverage to patrons of the entertainment venue.

### DESCRIPTION OF THE DRAWINGS

FIG. 1 is a schematic front elevation of one embodiment of apparatus, in the form of an insert, for generating artificial cold clouds at locales at which beverages are dispensed.

FIG. 2 is a schematic rear elevation of the apparatus illustrated in FIG. 1.

FIG. 3 is a schematic front elevation of a vendor box of the type conventionally carried by vendors selling beer and other beverages in stadia where sporting competitions are conducted.

FIG. 4 is a schematic front elevation of the vendor box illustrated in FIG. 3, with the apparatus illustrated in FIGS. 1 and 2 positioned therein.

FIG. 5 is a schematic side elevation, partially cut away, of a second embodiment of apparatus for providing artificial cold clouds at locales at which beverages are dispensed.

FIG. 6 is a schematic view similar to FIG. 5 illustrating dry ice in position within the apparatus illustrated in FIG. 5.

FIG. 7 is a schematic left side elevation of the apparatus illustrated in FIGS. 5 and 6.

FIG. 8 is a schematic representation of a kiosk, which may be located within an athletic stadium or other public place, illustrating the manner in which the apparatus disclosed in FIGS. 5 through 7 may be positioned.

FIG. 9 is an enlarged schematic front elevation of the vendor box illustrated in FIG. 3, with the apparatus illustrated in FIGS. 1 and 2 positioned therein similarly to FIG. 4, showing the flow of air during use of the apparatus.

FIG. 10 is an schematic top and side view of the apparatus illustrated in FIG. 4 and FIG. 9.

FIG. 11 is a schematic top view of the apparatus illustrated in FIG. 4.

### DETAILED DESCRIPTION

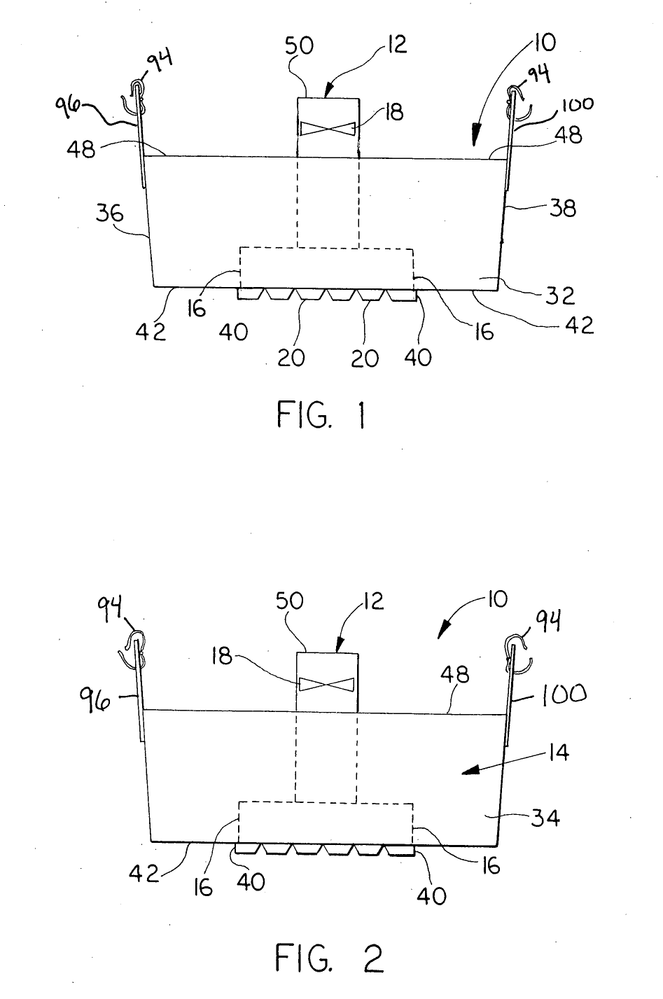

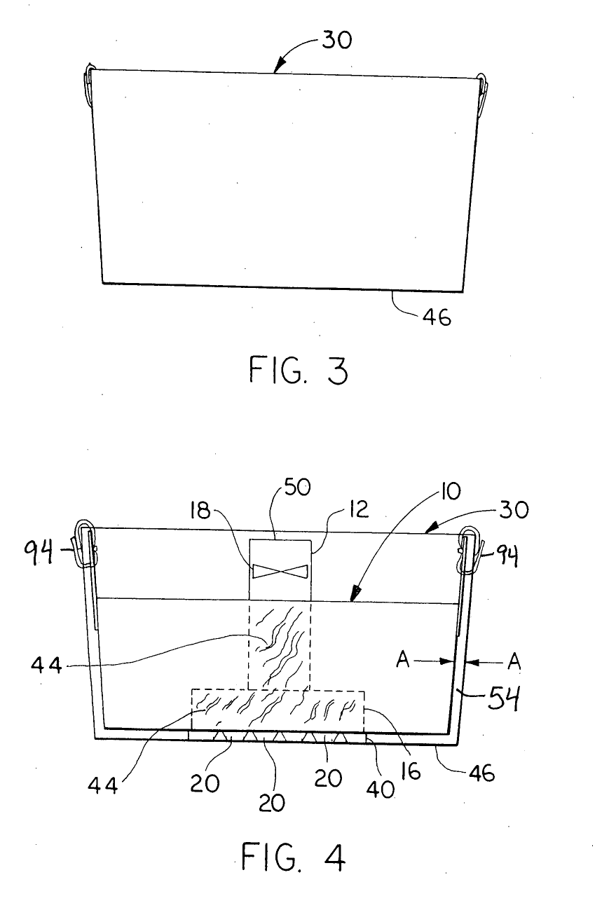

Referring to the drawings in general and to FIGS. 1 and 2 in particular, the apparatus for generating cold appearing clouds is designated generally 10 and is preferably constructed in a form of an insert to fit within an enclosure designated generally 30 and shown in FIG. 3 as a vendor box. Insert apparatus 10 has a front wall 32, a rear wall 34, a left side wall 36, and a right side wall 38, with the front, rear, left side and right side walls tapering somewhat from top to bottom as illustrated in FIGS. 1 and 2, so that the bottom or floor 42 of apparatus 10 is smaller in total area than the open top 48 of apparatus 10.

Insert apparatus 10 may be fabricated from plastic with the joints between respective walls 32, 34, 36 and 38 formed by either thermal welding or using suitable adhesive. Walls 32, 34, 36, 38 are preferably solid plastic and are thick enough, for example on the order of ⅜ of an inch, as to be sufficiently rigid to resist bending when moderate loads are applied. Alternatively, insert apparatus 10, specifically walls 32, 34, 36 and 38 thereof, may be fabricated from metal such as, but not limited to, aluminum wherein the metal insert is capable of resisting bending when moderate loads are applied. Additionally, the structural integrity of the insert apparatus is able to withstand cold temperatures such as temperatures associated with the contact of dry ice.

Handles 96, 100 may extend from the walls of the insert. Preferably, a first handle 96 may be coupled to the left side wall 36 of the insert 10 and a second handle 100 may be coupled to a right side wall 38 of the insert such that both handles 96, 100 are coupled to opposing side walls of the insert. As illustrated in FIGS. 1, 2 and 10, the handles may extend from side walls 36, 38 such that a user may lift the insert 10 by the handles 96, 100. However, the figures are intended only for illustrative purposes and the handles 96, 100 may be in any form understood in the art to facilitate lifting the insert 10.

The top 48 of insert apparatus 10 is preferably open while the floor 42 of insert apparatus 10 may be perforate or may contain at least one hole. Floor 42 may be fabricated using hardware cloth or other screen-like material secured in place, or may be a piece of plastic thermally bonded or adhesively bonded to the lower edges of front, rear, left side and right side walls 32, 34, 36 and 38 and thereafter drilled to provide the required perforate character for insert floor 42. However, the present invention is not limited to this embodiment and the floor 42 may be a solid piece of plastic or metal with similar characteristics attributed to the insert walls 32, 34, 36, 38.

The enclosure 30 may be a vendor box of the type that is well-known to anyone who has attended a baseball game in a major or minor league stadium. Specifically, the enclosure 30 conventionally is equipped with straps permitting a carrier to place the straps around the carrier's neck (not illustrated), thereby distributing the load of the enclosure over the carrier's neck and shoulders. The enclosure 30 may be insulated and may include a top (not illustrated) to maintain beverages in the enclosure at a cold temperature.

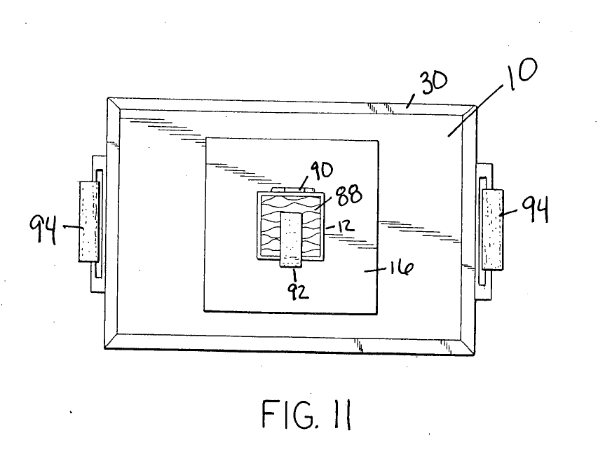

Referring to FIG. 4 and FIG. 10, insert apparatus 10 is preferably dimensioned so as to fit within the enclosure 30 in the manner illustrated. Additionally, as illustrated by FIG. 4 and FIG. 10, the insert 10 may be secured to the enclosure 30. In one embodiment, the insert may be secured to the enclosure by a plurality of clasps 94 wherein the clasps 94 are coupled to the handles 96,100 of the insert 10. In one embodiment, the clasps 94 may secure the insert to the enclosure by clasping the handles 96, 100 of the insert 10 to handles of the enclosure, referenced generally as 98. For example, as illustrated, the clasps may utilize a hook and loop system, such as Velcro, wherein the clasps 94 substantially surround one of the insert's handles 96, 100 and one of the enclosure's handles 98. To this end, when a carrier lifts the insert by the handles 96, 100 he or she also lifts the enclosure by the handles 98 such that the insert and the enclosure are lifted as one unit. The present invention is not limited to this embodiment, however, and may be comprised of any method understood in the art to secure and insert to an enclosure such as, but not limited to, clips, screws, rope, or the like wherein the method of securing facilitates the lifting of both the insert and enclosure as one unit.

Referring to FIGS. 1, 2 and 10, insert apparatus 10 further includes a storage silo 12 which is upstanding relative to the walls of insert apparatus 10 and desirably extends above the open top 48 of insert apparatus 10. Storage silo 12 is adapted to retain dry ice therewithin and has a fan, designated generally 18 in FIGS. 1 and 2, within the unnumbered upper region of storage silo 12. Fan 18 is electrically powered by a battery and motor combination (not illustrated in the drawings). Fan 18 is shown only in schematic form in the drawings and may be comprised of any fan 18 which may be mounted within a silo 12 such that the blades of the fan may rotate freely about an axis without contacting the silo 12.

Fan 18 is also mounted within the silo such that it draws air downwardly through storage silo 12 with air entering storage silo 12 at the upper, open end thereof, which is designated generally 50 in FIGS. 1 and 2. Referring to FIGS. 10 and 11, a lid 88 may cover an open top 50 in the upper, open end of the storage silo 12. The lid 88 may be perforated, porous, or in any configuration understood in the art to allow air to pass through the lid 88 and downwardly through the storage silo 12. In one embodiment, the lid 88 may be a porous or metal mesh, such as an aluminum mesh screen, wherein the lid 88 is coupled to the open top 50 of the storage silo 12. The lid 88 may be coupled by a hinge 90, as illustrated in FIGS. 10 and 11, or by any mechanism understood in the art to couple a mesh screen over a top such that debris is precluded from entering the storage silo 12 without interfering with the air flow into the storage silo 12. The lid 88 may also be secured to the storage silo using retaining latch 92 preferably in the form of a hook and loop system, such as Velcro. In addition to securing the lid 88 to the storage silo 12, the retaining latch may prevent any escape of the dry ice in the event vendor box 30 is accidentally overturned.

Storage silo 12 is further configured to retain dry ice in the lower portion of storage silo 12, where the dry ice is indicated by wavy lines in FIG. 4 and is designated generally 44 in the drawings. As apparent from FIG. 4, storage silo 12 is preferably dimensioned and configured such that open top 50 of storage silo 12 is slightly below the upper extremity of enclosure 30.

Storage silo 12 preferably is mounted on a manifold 16 above the hole in the floor 42 of the insert 10, which preferably extends horizontally along a portion of the bottom of insert apparatus 10 and protrudes below insert floor 42 in the manner illustrated in FIGS. 1 and 2. Referring to FIG. 11, the manifold 16 may be substantially centered within the insert 10 and covering the hole in the insert (not illustrated). The silo 12 may be substantially centered on the manifold 16. The interior of manifold 16 is in fluid communication with the interior of storage silo 12 such that dry ice may be placed in the interior of manifold 16, in the position illustrated in FIG. 4, by dropping pieces of dry ice into storage silo 12 through open top 50. Once the dry ice 44 is dropped into open top 50 of storage silo 12 it may be distributed throughout the manifold 16 and storage silo 12. For example, the vendor may vigorously shake the insert apparatus 10 after dropping the dry ice into the storage silo 12, with the shaking being from side to side, wherein the shaking serves to distribute the dry ice throughout manifold 16 in the manner illustrated generally in FIG. 4 in schematic form.

Feet 20 extend downwardly from and below the plane defined by insert floor 42. To this end, the feet 20 extend from the hole in the floor of the insert 10 and serve to keep the assembly of storage silo 12 and manifold 16 raised relative to the bottom interior of the enclosure 30, where the bottom of vendor box 30 is designated 46 in FIGS. 3 and 4.

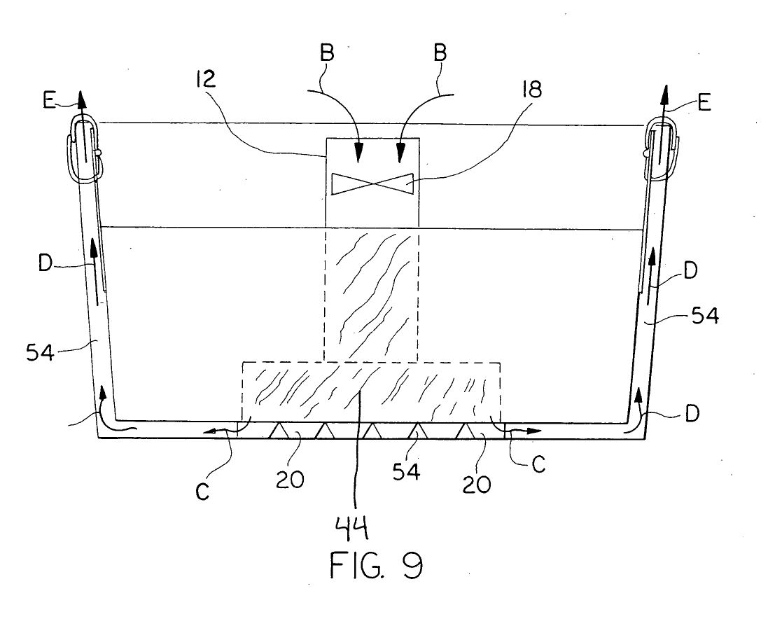

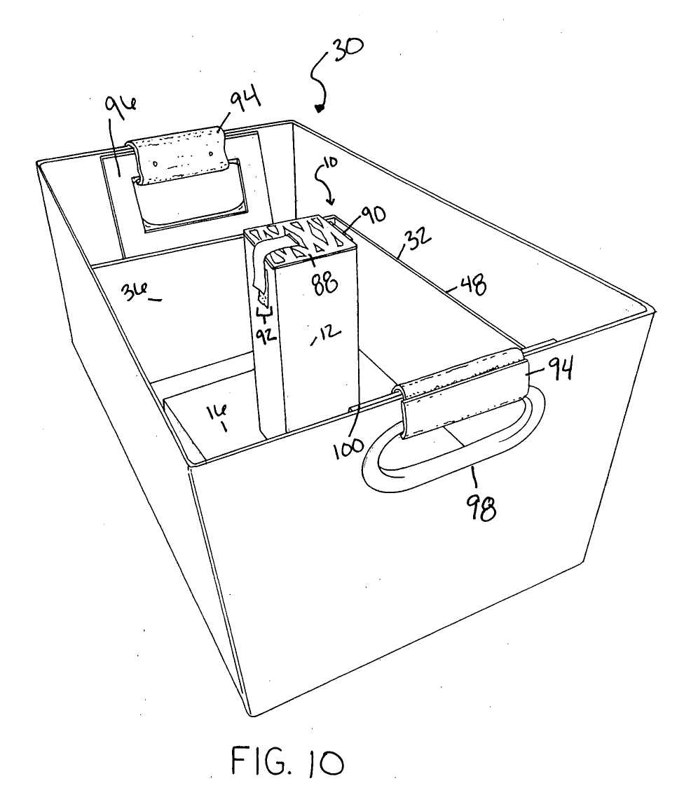

Extending from the floor 42 of the insert 10 is a diffuser plate, designated generally 40 in FIGS. 1, 2 and 4, wherein the diffuser plate 40 preferably runs along and is preferably coplanar with the lower extremities of supporting feet 20. Diffuser plate 40 has an upwardly extending lip portion, not numbered in the drawings, which is coincident with the vertically extending sides of manifold 16, as is apparent in FIGS. 1, 2 and 4. Diffuser plate 40 serves to force air that is driven downwardly within storage silo 12 by fan 18, to move laterally upon exiting manifold 16, in the directions indicated by arrows C in FIG. 9.

In order to facilitate the air flow indicated by arrows C in FIG. 9, insert apparatus 10 is dimensioned to fit within the enclosure 30 in the manner illustrated in FIG. 4 so that there is a gap, denoted by arrows A-A in FIG. 4 and designated generally 54, between the vertically extending walls 32, 34, 36, 38 of insert apparatus 10 and the inner surfaces of the generally vertically extending walls of the enclosure 30. The vertically extending walls of the enclosure 30 have not been numbered in the drawings to insure drawing clarity.

In FIG. 9, air flow into storage silo 12 is denoted by arrows B, where the air is drawn through the lid 88 and into storage silo 12 by the action of fan 18, and is pushed downwardly through the pieces of dry ice 44 occupying the lower portion of storage silo 12 and manifold 16. The air exits manifold 16, as indicated by arrows C in FIG. 9, and travels through gap 54 between generally vertically upstanding walls 32, 34, 36, 38 of insert apparatus 10 and the inner surfaces of the vertically extending, unnumbered walls of vendor box 30, with such air being indicated by arrows D. The air then exit the enclosure 30 as indicated by arrows E.

With the air having passed over dry ice 44 residing within the lower portion of storage silo 12 and within manifold 16, the warm air causes the dry ice to sublimate to some extent and the cold dry ice causes moisture in the air to condense. This creates a cold-appearing cloud as the sublimated, now gaseous, carbon dioxide from the dry ice and the condensed water vapor are carried by the air, as indicated by arrows C, D and E, upwardly and outwardly from the enclosure 30.

As a result of the configuration of insert apparatus 10, such that the vertically extending walls 32, 34, 36, 38 are spaced from the interior surfaces of the unnumbered vertically extending walls of the enclosure 30 to create gap 54 therebetween, the cold appearing clouds emanate upwardly from around the entire periphery of the enclosure 30 as the vendor carries the vendor box through the stadium. This effect is eye catching and serves to stimulate and enhance sales of beverages which may be carried by the vendor within the insert and/or enclosure such that the beverages are kept in the space between the walls 32, 34, 36, 38, the floor 42 and the silo 12 of the insert.

Fan 18 preferably has blades that are sufficiently large and sufficiently spaced apart to allow passage therethrough of the chunks of dry ice as the dry ice is loaded into silo 12 via opening 50. Alternatively, fan 18, and the motor and battery driving fan 18, may be adapted be easily removed, on a temporary basis, from silo 12, to allow silo 12 and manifold 16 to be filed with dry ice whereupon fan 18 and its drive motor and battery may be replaced.

With the configuration of insert apparatus 10 relative to vendor box 30, there is no direct contact of the dry ice with water resulting from melting of conventional ice carried within the vendor box or within the interior of insert apparatus 12, nor there is any contact of the dry ice with the beverages resident within the interiors of insert apparatus 10 and vendor box 30.

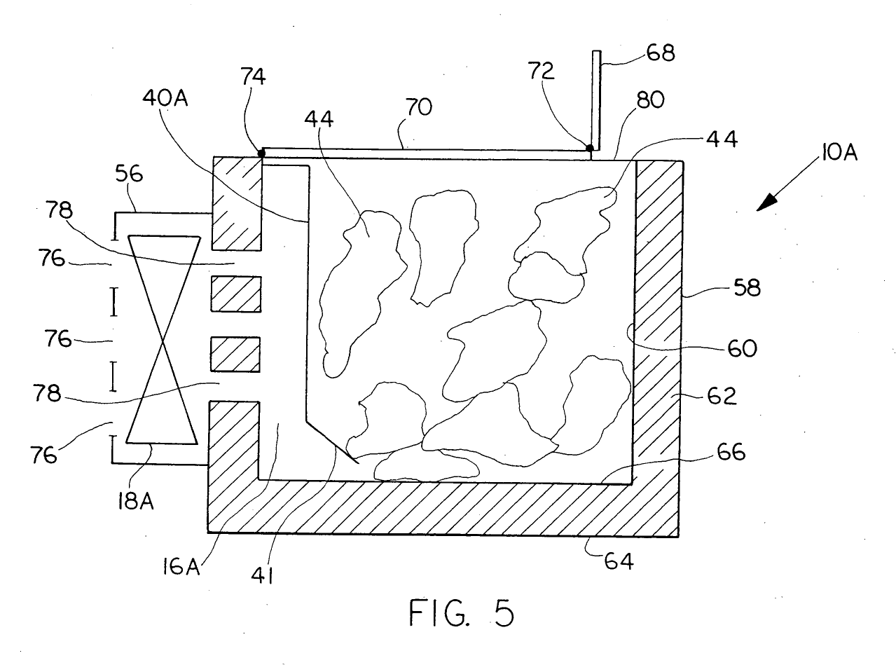

Referring to FIGS. 5, 6 and 7, an alternate embodiment of apparatus for generating cold clouds is illustrated and designated generally 10A where the apparatus is of generally configured as a rectangular chamber. Apparatus 10A preferably has an outer wall 58, an inner wall 60, and insulation 62 between inner and outer walls 60, 58, all as generally illustrated in FIG. 5. Apparatus 10A further includes a fan 18A that is analogous to fan 18 illustrated in FIGS. 1, 2 and 4. Fan 18A is preferably housed within a fan housing 56 mounted on one of the outer wall 58 of one of the vertically upstanding sides of apparatus 10A. A plurality of air inlets 76 are preferably formed in a vertically upstanding wall portion of fan housing 56; this vertically upstanding wall portion has not been numbered in the drawings.

Further formed in outer wall 58, inner wall 60 and through insulation 62 are a plurality of air passages 78 for passage therethrough of air drawn inwardly by operation of fan 18A through air inlets 76, into a manifold region 16A formed along an inner surface of inner wall 60, where the inner surface of inner wall 60 has not been numbered in the drawings. Manifold 16A is preferably bounded in part by a diffuser plate 40A that is preferably spaced away from the inner surface of inner wall 60 to define manifold 16A, as illustrated in FIG. 5. Diffuser plate 40A has a canted portion 41 located at the bottom of diffuser plate 40A, with a bottom extremity of canted portion 41 preferably being spaced away from inner bottom 66 of apparatus 10A, again as illustrated in FIG. 5.

Apparatus 10A further includes a flap 68 connected via a hinge 72 preferably to a lid 70, wherein the lid covers the top of the chamber portion of the apparatus 10A. The lid 70 may be secured to the top of the apparatus 10A by a hinge 74, all as illustrated in FIG. 5. During operation, flap 68 is normally in the position illustrated in FIG. 5; that is, flap 68 extends upwardly thereby to create an exhaust opening 80 at an upper extremity of the open interior of the rectangular box-like portion of apparatus 10A. The open interior has not been numbered in the drawings. Preferably resident within the open interior of apparatus 10A are pieces of dry ice denoted 44 in FIG. 5.

During operation of apparatus 10A, fan 18A, which is preferably driven by a motor powered by a battery, neither of which are illustrated in the drawing, draws air inwardly, from left to right in FIG. 5, through air inlets 76 and through air passageways 78 into manifold 16A. The air is then pushed, due to the action of fan 18A, downwardly in manifold 16A past the lower lip of canted portion 41, whereupon the air travels through the interstices between the pieces of dry ice 44 resident within the open interior chamber of apparatus 10A. The air, which may be warm and moist since apparatus 10A preferably is used, but not limited to, in the summer, causes some sublimation of the dry ice 44 and the dry ice causes moisture in the air to condense. The condensed moisture carried by the air and the sublimated carbon dioxide form a cold-appearing cloud as the air exits exhaust opening 80.

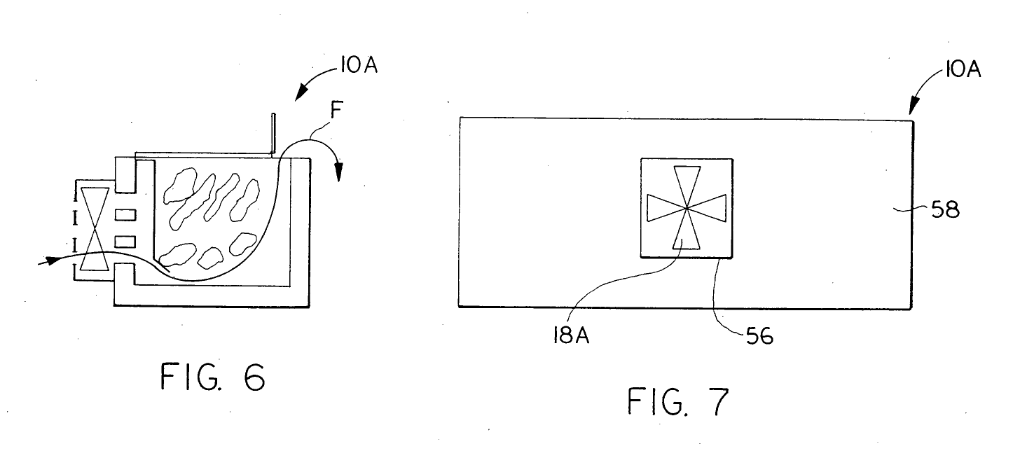

The general flow of the air using apparatus 10A is illustrated by arrow F in FIG. 6.

The configuration of fan housing 56 and fan 18A relative to outer wall 58 of apparatus 10A is illustrated in FIG. 7.

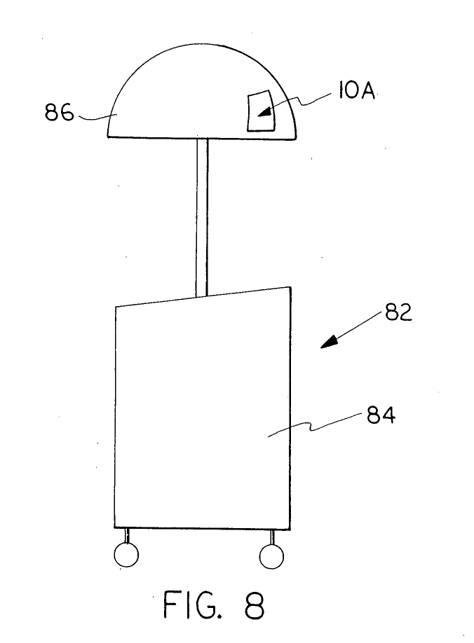

Apparatus 10A is intended to be fabricated in a somewhat miniaturized scale so that apparatus 10A may be mounted within the umbrella or canopy of a kiosk from which beer or other beverages are dispensed in a stadium. The apparatus 10A may be mounted by an mechanism understood in the art to mount a air controlling mechanism, such as a fan, to an umbrella, cover or canopy. Such orientation and positioning of apparatus 10A in the umbrella or cover or canopy 86 of such a kiosk 82 having a beverage storage and dispensing unit 84, is preferably in the form of a beer keg and tap, is illustrated in FIG. 8. To this end, the carbon dioxide and water vapor created by the apparatus 10A serves to signal to a patron of an entertainment venue that a cold beverage is contain within the dispensing unit 84 and may be purchased there.

1. Apparatus for generating the appearance of clouds comprising:
an insert comprising four sides, a bottom and a top coupled to form a rectangular configuration wherein the insert fits within an enclosure comprised of four sides, a bottom and a top;
a manifold coupled to the bottom of the insert proximate to a hole in the bottom of the insert;
feet extending from the bottom of the insert wherein the feet support the insert within the enclosure and create a gap between the insert and the enclosure;
a diffuser plate extending from the bottom of the insert;
a silo extending from the manifold toward the top of the insert wherein an end of the silo which is distal to the manifold is open and the silo is in fluid communication with the manifold; and
a fan mounted within the silo such that the fan directs air flow from the open end of the silo through the silo and manifold such that the diffuser plate directs the air flow from the manifold into the gap between the enclosure and the insert.

2. The apparatus of claim 1 wherein the insert is adapted to fit within the enclosure such that a top of the silo is above the top of the insert and below a top of the enclosure.

3. The apparatus of claim 1 wherein the four sides of the insert taper from the top of the insert to the bottom of the insert to define a bottom area of the box smaller than the top area of the box.

4. The apparatus of claim 1 further comprising a lid wherein the lid is secured to the silo such that it covers the open top of the silo and is adapted to allow air to pass through the lid and into the silo.

5. The apparatus of claim 4 wherein the lid is secured to the silo by a hinge.

6. The apparatus of claim 4 wherein the lid is secured to the silo by a hook and loop system.

7. The apparatus of claim 1 wherein two handles extend from the sides of the insert such that the handles extend from opposing sides of the insert.

8. The apparatus of claim 7 wherein the handles of the insert are juxtaposed to handles of the enclosure.

9. The apparatus of claim 8 wherein the handles of the insert are secured to the handles of the enclosure when the insert is within the enclosure.

10. The apparatus of claim 9 wherein the handles of the insert are secured to the handles of the enclosure by a clasp.

11. The apparatus of claim 1 wherein the enclosure is a vendor box.

12. The apparatus of claim 1 wherein the silo and the manifold are adapted to receive dry ice.

13. The apparatus of claim 1 wherein the insert is adapted to hold cooled beverages within a space between the four sides of the insert, bottom of the insert, manifold and silo.

14. Apparatus for generating the appearance of clouds comprising:
an insert comprising four sides, a bottom and a top coupled to form a chamber comprised of an outer wall and an inner wall wherein a first side has a plurality of holes extending through the outer wall and the inner wall wherein the insert is mounted to an enclosure;
a lid which is pivotally secured to the top of the insert;
a flap which is pivotally secured to the lid wherein the flap may pivot to open a portion of the lid;
a manifold mounted on the inner wall of the first side of the insert;
a diffuser plate extending from the manifold distal to the inner wall of the first side of the insert;
a fan housing mounted on the outer wall of the first side of the insert such that the housing is over the plurality of holes in the first side; and
a fan mounted within the housing such that the fan directs air flow though the fan housing and the holes in the first side of the insert such that the manifold and diffuser direct the air flow into the chamber of the insert and out of the flap.

15. The apparatus of claim 14 wherein the enclosure is an umbrella of a kiosk.

16. The apparatus of claim 14 wherein the enclosure is a canopy of a kiosk.

17. The apparatus of claim 14 further comprising a canted portion extending from the diffuser plate.

18. The apparatus of claim 14 further comprising an insulation layer between the outer wall and the inner wall.

19. The apparatus of claim 14 wherein the chamber of the insert is adapted to receive dry ice.

20. The apparatus of claim 14 wherein the enclosure is coupled to a kiosk wherein the kiosk stores cold beverages.

21. A method for generating the appearance of clouds comprising:
directing an air flow from a fan into a manifold of an insert contained within an enclosure wherein the insert contains dry ice;
passing the air flow over the dry ice such that the dry ice sublimates creating carbon dioxide and the moisture in the air condenses;
carrying the carbon dioxide and condensed moisture away from the dry ice by the air flow directed from the fan;
directing the air flow, carbon dioxide and condensed water vapor out of the manifold, the insert and the enclosure by a diffuser plate such that the air flow, carbon dioxide and water condensation creates a cloudy appearance around the enclosure.

22. A method of claim 21 further comprising storing a cooled beverage within the insert wherein the cooled beverage does not come into contact with the dry ice.

23. A method of claim 22 wherein the cooled beverage is beer.

24. A method of claim 21 further comprising storing a cooled beverage within a kiosk wherein the enclosure is mounted to the kiosk.

25. A method of claim 21 further comprising carrying the enclosure and insert throughout an entertainment venue wherein the direction of air flow, carbon dioxide and condensed water vapor out of the enclosure creates the impression of a cooled beverage within the insert.

26. A method of claim 24 wherein the entertainment venue is a baseball stadium.

27. The method of claim 21 wherein the step of directing air flow, carbon dioxide and water vapor out of the enclosure creates the impression of a cooled beverage within the insert.
